(19) United States
(12) Patent Application Publication
(10) Pub. No.: US 2008/0191027 A1
(43) Pub. Date: Aug. 14, 2008

(54) SEMICONDUCTOR NANOCRYSTALS AS MARKING DEVICES

(76) Inventors: San Ming Yang, Troy, NY (US); Luis A. Sanchez, Albany, NY (US); James C.M. Hayes, Homer, NY (US); Eva Marie Sackal, Altamont, NY (US)

Correspondence Address: HOFFMAN WARNICK LLC, 75 STATE STREET, 14TH FLOOR, ALBANY, NY, 12207, US

(21) Appl. No.: 12/029,640

(22) Filed: Feb. 12, 2008

Related U.S. Application Data
(60) Provisional application No. 60/900,790, filed on Feb. 12, 2007.
(60) Provisional application No. 60/936,371, filed on Jun. 20, 2007.

(51) Int. Cl. G06K 19/06; B05D 5/06

(52) U.S. Cl. 235/491; 427/7; 977/932

(57) ABSTRACT

The invention provides devices and methods for marking an object using semiconductor nanocrystals. In some embodiments, marking devices according to the invention include semiconductor nanocrystals patterned to form a barcode, the semiconductor nanocrystals being selected from a group consisting of: CdSe, CdS, CdTe, InAs, InSb, InGaSb, InGaN, InGaP, InP, GaP, GaN, HgTe, HgSe, HgS, CnS, ZnSe, ZnS, ZnCdSe, PbS, PbSe, PbTe, CuInGaS₂, CuInGaSe₂, ZnCuInGaS₂, and ZnCuInGaSe₂.

### CROSS REFERENCE TO RELATED APPLICATIONS

This application claims the benefit of co-pending U.S. Provisional Application Nos. 60/900,790, filed 12 Feb. 2007 and 60/936,371, filed 20 Jun. 2007, each of which is hereby incorporated herein.

### TECHNICAL FIELD

The invention relates generally to the use of nanocrystals and, more particularly, to the use of nanocrystals to mark and/or identify an object. In some embodiments, nanocrystals are incorporated into a computer-readable barcode pattern.

### BACKGROUND OF THE INVENTION

Inorganic semiconductor nanocrystals (quantum dots) have proved useful in a number of applications. Due to the small size of these crystals (typically between about 2 nm and about 10 nm), quantum confinement effects are manifest and result in size, shape, and compositionally-dependent optical and electronic properties. Quantum dots have a tunable absorption onset that has increasingly large extinction coefficients at shorter wavelengths, multiple observable excitonic peaks in the absorption spectra that correspond to the quantized electron and hole states, and narrowband tunable band-edge emission spectra. Quantum dots absorb light at wavelengths shorter than the modified absorption onset and emit at the band edge.

Because they are inorganic, nanocrystals are orders of magnitude more robust than organic molecules and organic fluorophores and do not photo bleach. Nanocrystals can be and often are surface modified with multiple layers of inorganic and organic coatings in order to further engineer the electronic states, control recombination mechanisms, and provide for chemical compatibility with solvent or matrix material in which the nanocrystals are dispersed.

Quantum confinement effects originate from the spatial confinement of intrinsic carriers (electrons and holes) to the physical dimensions of the material rather than to bulk length scales. One of the better-known confinement effects is the increase in semiconductor band gap energy with decreasing particle size; this manifests itself as a size-dependent blue shift of the band edge absorption and luminescence emission with decreasing particle size. As nanocrystals increase in size past the exciton Bohr radius, they become electronically and optically bulk-like. Therefore, nanocrystals cannot be made to have a smaller bandgap than that exhibited by the bulk materials of the same composition. By properly engineering the core and semiconductor shells in terms of size, thickness, and composition, core to shell electronic transitions can be engineered that have below bandgap (of the core) emission. Such nanocrystals are referred to as type-II nanocrystals.

Quantum dots will emit light at a wavelength slightly longer than that of the first exciton peak. That difference, the Stokes shift, is a function of the emission wavelength and composition of the nanocrystals. For example, the Stokes shift for CdSe is about 15 nm and about 50 nm for PbSe. The emission wavelength is independent of the excitation wavelength, assuming of course that the emission wavelength is shorter than the first exciton peak (i.e., where it can be absorbed) and does not significantly overlap with the emission spectra. For example, a nanocrystal designed to emit light at 600 nm will emit at that wavelength whether excited with 350 nm or 500 nm light sources. Excitation sources near that of the emission wavelengths will only allow for a subset of the possible wavelengths to be emitted (those having a longer wavelength than the excitation source). The emission spectra is roughly Gaussian (bell shaped) and does not have the shoulders and secondary peaks exhibited by organic fluorophores.

Compared to organic dyes and fluorophores that bleach very quickly, quantum dots are over three orders of magnitude more photostable. Quantum dots are typically made of II-VI, III-V, IV-VI, II-III-VI, I-III-VI, and group II alloyed I-III-VI materials, and have a diameter between about 1 nm and about 20 nm. Examples of such compounds include, for example, CdSe, CdS, CdTe, InAs, InSb, InGaSb, InGaN, InGaP, InP, GaP, GaN, HgTe, HgSe, HgS, CnS, ZnSe, ZnS, ZnCdSe, PbS, PbSe, PbTe, CuInGaS₂, CuInGaSe₂, ZnCuInGaS₂, and ZnCuInGaSe₂.

One or more semiconductor shells that envelop each nanocrystal core may be provided in order to increase the quantum yield and robustness of the nanocrystals. Examples of such shells include, for example, ZnS, ZnSe, and CdS.

Quantum dots having infrared emission can be found in the class of II-VI type II core-shell dots such as CdTe/CdSe, IV-VI dots such as PbS and PbSe, and I-III-VI₂ dots such as CuInS₂ and CuInSe₂. The quantum yield of IV-VI PbS quantum dots can be as high as 50%, which is far better than any organic NIR dye available. Other IR-emitting materials and spectral elements can be combined with such nanocrystals.

Another class of emissive nanocrystals is based on rare-earth compounds, such as oxides, phosphates, fluorides, vanadates, and sulfides. Their unique properties arise from the 4f electron configuration and their potential applications are numerous, such as ultraviolet absorbents, solid-state lasers, optical amplifiers, lighting, displays, and biolabels. Yttrium, gadolinium, and/or lanthanum are commonly used as the basic lattice (host lattice material, matrix material). These materials use multiphoton excitation of active lattices with dopants from the rare earth metal group, in particular erbium in combination ytterbium, in order to generate more energetic photons, and therefore visible light, from a plurality of low-energy infrared photons.

### SUMMARY OF THE INVENTION

The invention provides devices and methods for marking an object using semiconductor nanocrystals. In some embodiments, marking devices according to the invention include semiconductor nanocrystals patterned to form a barcode, the semiconductor nanocrystals being selected from a group consisting of: CdSe, CdS, CdTe, InAs, InSb, InGaSb, InGaN, InGaP, InP, GaP, GaN, HgTe, HgSe, HgS, CnS, ZnSe, ZnS, ZnCdSe, PbS, PbSe, PbTe, CuInGaS₂, CuInGaSe₂, ZnCuInGaS₂, and ZnCuInGaSe₂.

A first aspect of the invention provides a device for marking an object comprising: a first portion including semiconductor nanocrystals; and a second portion not including semiconductor nanocrystals, wherein the first and second portions form a first marking pattern under a first wavelength of light and a second marking pattern under a second wavelength of light, the second wavelength of light being capable of exciting the semiconductor nanocrystals of the first portion.

A second aspect of the invention provides a device for marking an object comprising: a portion including semiconductor nanocrystals, wherein the portion including semiconductor nanocrystals forms a marking pattern under a wavelength of light shorter than an emissive wavelength of the semiconductor nanocrystals and does not form a marking pattern under a wavelength of light longer than the emissive wavelength of the semiconductor nanocrystals.

A third aspect of the invention provides a method of marking an object comprising: applying semiconductor nanocrystals to a surface of the object, wherein the semiconductor nanocrystals form a marking pattern under a wavelength of light longer than an emissive wavelength of the semiconductor nanocrystals.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a known linear barcode.

FIG. 2 shows an illustrative linear barcode according to an embodiment of the invention.

FIGS. 3A-B show an illustrative hidden linear barcode according to an embodiment of the invention.

FIG. 4 shows a known matrix barcode.

FIGS. 5-6 show an illustrative covert matrix barcode according to an embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As noted above, the invention is directed toward the use of nanocrystals for the marking and/or identification of an object. In some embodiments, the invention includes the incorporation of nanocrystals into a barcode pattern. Such a use of nanocrystals for marking and/or identification may be covert, i.e., the presence of the nanocrystals cannot be determined with the unaided eye, or overt, i.e., the presence of the nanocrystals may be determined with the unaided eye, but their use cannot be duplicated.

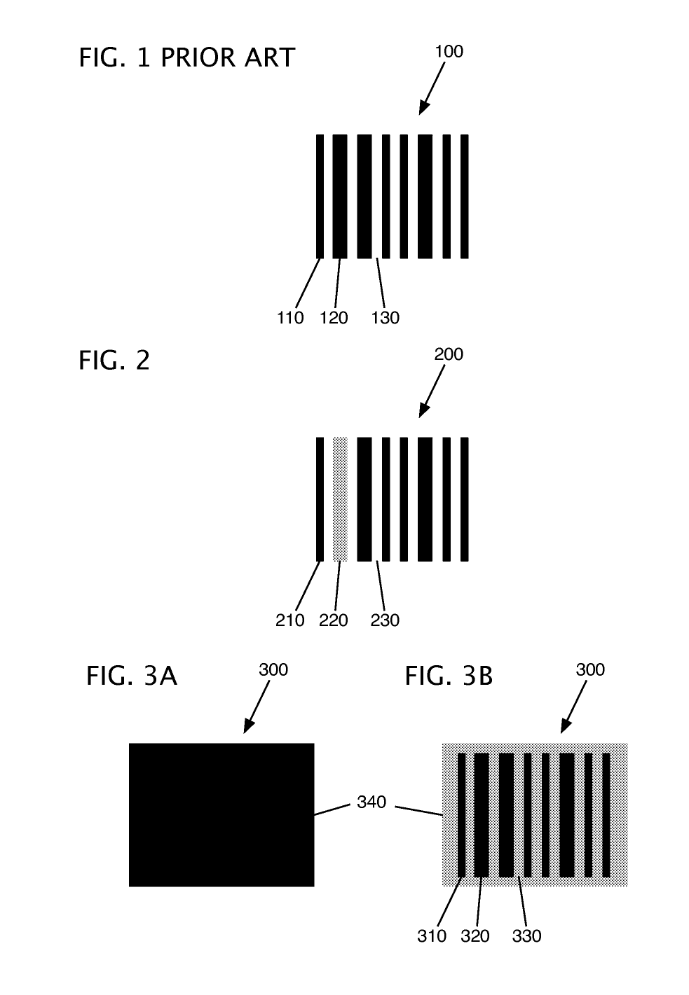

Referring now to the drawings, FIG. 1 shows an example of a conventional linear (one-dimensional) barcode 100 comprising parallel narrow bars 110 and wide bars 120, with spaces 130 therebetween. Typically, bars 110, 120 are black in color and spaces 130 are white in color, in order to provide contrast in reflected light when the barcode 100 is scanned by an optical scanner. Other colors are sometimes used, such as cyan and magenta, which are typically detected as black and white, respectively.

Most optical scanners use a red light emitting diode (LED) light source in the range of about 630 nm to about 680 nm (most often between about 650 nm and about 660 nm). The red light is absorbed by bars 110, 120 and reflected by spaces 130. Reflected light is detected by a photodetector, such as a photodiode, phototransistor, or CCD detector. Such photodetectors exhibit a broad spectral response, often into the near infrared (NIR) region (between about 800 nm and about 1000 nm). Thus, most photodetectors recognize NIR emissive materials as white.

FIG. 2 shows an illustrative linear barcode 200 according to an embodiment of the invention. One wide bar 220 includes emissive semiconductor nanocrystals. Such nanocrystals may be suspended in a liquid ink of the same color as that used to print the other bars 210 of the barcode 200 (thereby comprising a covert marking device) or of a different color (thereby comprising an overt marking device).

Nanocrystals may be applied to a surface to form a barcode or similar marking pattern by any known or later-developed method or technique, including, for example, gravure printing, off-set printing, inkjet printing, silk screening, lithographic or flexographic techniques. Similarly, while generally described as being printed using an ink, it should be recognized that barcodes or similar marking devices may be formed using other fluids, such as paints, powders, or other suitable media.

As described above, when the barcode 200 is subjected to a wavelength of light shorter than that of the emissive wavelength of the nanocrystals, the nanocrystals will emit light at their particular emissive wavelength. Thus, in the case that the nanocrystals of the wide bar 220 have an emissive wavelength of 600 nm, they will emit light at that wavelength when light of a shorter wavelength (e.g., 500 nm) is applied to them. It is possible, therefore, to determine whether the barcode 200 is genuine by applying a 500 nm lightsource to the barcode 200 and determining whether the wide bar 220 fluoresces. It is similarly possible to embed additional information (e.g., security information, a source identifier, an owner's name, a serial number, a production date, etc.) within a barcode 200 using one or more “nanocrystal-tagged” bars.

In some embodiments of the invention, nanocrystals having different emissive wavelengths are used in different bars of a barcode or similar marking pattern, thereby increasing the information density of the barcode or marking pattern.

In other embodiments, such as that shown in FIGS. 3A-B, standard bars or other barcode elements may be printed atop a printed field 340 containing nanocrystals in an ink of the same color as the bars, such that no pattern may be discerned (as in FIG. 3A) until a wavelength shorter than the emissive wavelength of the nanocrystals is applied to it. Once such a wavelength is applied, the barcode pattern becomes visible (as in FIG. 3B) and readable by a barcode scanner. In such an embodiment, not only is the information coded in the nanocrystal portion of the barcode covert, but so is the barcode itself (i.e., the barcode itself may be undetectable with the unaided eye).

Similarly, other embodiments of the invention comprise a colorless covert barcode that is not detectable to the unaided eye, but which may be illuminated with a UV lightsource. Some elements (e.g., narrow and wide bars) absorb UV illumination, while other elements (e.g., spaces between the bars and/or a background field) appear as blue bars under UV illumination. Such an embodiment results in a two-tone barcode that requires the appropriate UV-A or UV-B illumination to be visible and/or readable.

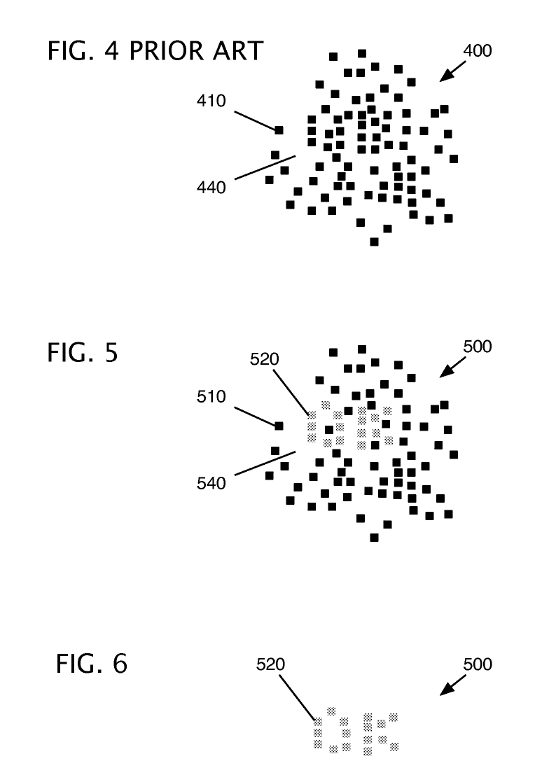

FIG. 4 shows a conventional matrix (two-dimensional) barcode 400, comprising a plurality of individual pixels 410 or other shapes patterned onto a field 440. Matrix barcodes are preferred in some applications, as they can contain more information than a linear barcode of the same size.

FIG. 5 shows a matrix barcode 500 according to an embodiment of the invention. Here, a subset 520 of the plurality of pixels 510 include semiconductor nanocrystals. Upon application of a wavelength shorter than that of the emissive wavelength of the nanocrystals, the subset 520 fluoresces, revealing a covert pattern, as shown in FIG. 6. The covert pattern of FIG. 6 is shown for illustrative purposes only. Much more complex and information-dense patterns may be included within the subset 520. Indeed, a second, distinct covert barcode may be contained entirely within a first, overt barcode.

Barcodes and other marking devices according to the invention provide inherent anti-counterfeiting protection in that a photocopied or similarly-duplicated version will not contain nanocrystals and cannot, therefore, function as would the original. For example, a copy of the matrix barcode of FIG. 5 would fail to reveal the covert pattern of FIG. 6 upon application of a wavelength shorter than the emissive wavelength of the nanocrystals.

As noted above, cyan inks are typically detected as black by standard barcode readers. Thus, in one embodiment of the invention, a visibly-detectable barcode pattern may be formed that is unreadable using a standard barcode reader by patterning either the bars, pixels, or other element in either black or cyan ink and a background in the other. For example, bars of a linear barcode may be printed in black over a cyan field. Such a barcode would be unreadable using a standard barcode reader, which would detect both colors as black, due to the low contrast between cyan and black under red LED light. However, the incorporation of nanocrystals (e.g., green emissive upconversion nanocrystals) into the cyan ink will render the barcode readable upon application of a wavelength shorter than the emissive wavelength of the nanocrystals.

Other embodiments of the invention provide anti-counterfeiting features. For example, a background field may be printed using an ink containing emissive nanocrystals, as described above. In addition, feature of the marking device, such as narrow and wide bars of a linear barcode, may be printed using a black ink with a high refractive index. The difference in refractive indices of the background field and the bars creates a high gloss image of the barcode, which cannot be reproduced by xerography. Examples of polymers that may be incorporated into an ink to produce a high refractive index include, for example, polyamide, polyester, polystyrene, polyacrylate, polyurethane, polyvinyl chloride, polyvinyl acetate, and polyvinylpyrrolidone. Other embodiments of the invention deter counterfeiting by the incorporation of near infrared (NIR) blockers into the marking device elements (e.g., the narrow and wide bars and/or the spaces therebetween).

Below are provided several examples of inks containing nanocrystals and methods useful in practicing various embodiments of the invention.

### EXAMPLE 1

A PbS nanocrystal black dyed ink for flexographic printing was prepared from the following materials: 115 mg PbS, 800 microliters toluene, 2.15 g Celvol 107 (15 wt % solution), and 200 microliters of direct black (0.2 M). All components were mixed by ultrasonification for two minutes at 450 W.

### EXAMPLE 2

A black dyed inkjet ink containing NIR blocker was prepared from the following materials: 200 mg ADS832WS (American Dye Source Inc.), 10 g WJ190 (Image Specialist). The ink was loaded into an empty Epson cartridge and printed from a Stylus Color 88+ printer.

### EXAMPLE 3

A fluorescent ink for flexographic printing containing PbS nanocrystals was prepared as follows.

Mixture A: 1 mL of PbS nanocrystals in toluene (emission maximum at 850 nm, 100 mg/mL) was mixed with 0.5 mL 5 wt % of solvent blue 38. The mixture was then mixed with a polyvinyl acetate emulsion (1.5 mL, XX210 from AirProducts). The resultant mixture was ultrasonicated for two minutes at 450 W.

Mixture B: 0.5 mL of 10% NIR absorbers (ADS920MC, American Dye Source Inc.) in dichloromethane was mixed with 1.5 mL of polyvinyl acetate (XX210 from AirProducts). The resultant mixture was ultrasonicated for two minutes at 450 W.

Equal weights of mixtures A and B were stirred together for 5 minutes. The resultant ink had a viscosity of 15 s in a Zahn Cup #3 test.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A device for marking an object comprising:
a first portion including semiconductor nanocrystals; and
a second portion not including semiconductor nanocrystals,
wherein the first and second portions form a first marking pattern under a first wavelength of light and a second marking pattern under a second wavelength of light, the second wavelength of light being capable of exciting the semiconductor nanocrystals of the first portion.

2. The device of claim 1, wherein the first marking pattern includes a barcode.

3. The device of claim 2, wherein the barcode includes a matrix barcode.

4. The device of claim 1, wherein the second wavelength of light is shorter than an emissive wavelength of the semiconductor nanocrystals.

5. The device of claim 4, wherein the emissive wavelength of the semiconductor nanocrystals is in the infrared range.

6. The device of claim 1, wherein the semiconductor nanocrystals are selected from a group consisting of: II-VI semiconductors, III-V semiconductors, IV-VI semiconductors, II-III-VI semiconductors, I-III-VI semiconductors, and group II alloyed I-III-VI semiconductors.

7. The device of claim 6, wherein the semiconductors are selected from a group consisting of: CdSe, CdS, CdTe, InAs, InSb, InGaSb, InGaN, InGaP, InP, GaP, GaN, HgTe, HgSe, HgS, CnS, ZnSe, ZnS, ZnCdSe, PbS, PbSe, PbTe, CuInGaS₂, CuInGaSe₂, ZnCuInGaS₂, and ZnCuInGaSe₂.

8. The device of claim 1, wherein the semiconductor nanocrystals have a diameter between about 1 nm and about 20 nm.

9. The device of claim 1, wherein the second marking pattern is covert.

10. A device for marking an object comprising:
a portion including semiconductor nanocrystals,
wherein the portion including semiconductor nanocrystals forms a marking pattern under a wavelength of light shorter than an emissive wavelength of the semiconductor nanocrystals and does not form a marking pattern under a wavelength of light longer than the emissive wavelength of the semiconductor nanocrystals.

11. The device of claim 10, further comprising:
an additional portion not including semiconductor nanocrystals,
wherein the portion including semiconductor nanocrystals and the additional portion not including semiconductor nanocrystals form the marking pattern under a wavelength of light shorter than the emissive wavelength of the semiconductor nanocrystals.

12. The device of claim 10, wherein the marking pattern includes a barcode.

13. The device of claim 12, wherein the barcode includes a matrix barcode.

14. The device of claim 10, wherein the emissive wavelength of the semiconductor nanocrystals is in the infrared range.

15. The device of claim 10, wherein the semiconductor nanocrystals are selected from a group consisting of: II-VI semiconductors, III-V semiconductors, IV-VI semiconductors, II-III-VI semiconductors, I-III-VI semiconductors, and group II alloyed I-III-VI semiconductors.

16. The device of claim 15, wherein the semiconductors are selected from a group consisting of: CdSe, CdS, CdTe, InAs, InSb, InGaSb, InGaN, InGaP, InP, GaP, GaN, HgTe, HgSe, HgS, CnS, ZnSe, ZnS, ZnCdSe, PbS, PbSe, PbTe, CuInGaS₂, CuInGaSe₂, ZnCuInGaS₂, and ZnCuInGaSe₂.

17. The device of claim 10, wherein the semiconductor nanocrystals have a diameter between about 1 nm and about 20 nm.

18. A method of marking an object comprising:
applying semiconductor nanocrystals to a surface of the object,
wherein the semiconductor nanocrystals form a marking pattern under a wavelength of light longer than an emissive wavelength of the semiconductor nanocrystals.

19. The method of claim 18, wherein the semiconductor nanocrystals are selected from a group consisting of: II-VI semiconductors, III-V semiconductors, IV-VI semiconductors, II-III-VI semiconductors, I-III-VI semiconductors, and group II alloyed I-III-VI semiconductors.

20. The method of claim 19, wherein the semiconductors are selected from a group consisting of: CdSe, CdS, CdTe, InAs, InSb, InGaSb, InGaN, InGaP, InP, GaP, GaN, HgTe, HgSe, HgS, CnS, ZnSe, ZnS, ZnCdSe, PbS, PbSe, PbTe, CuInGaS₂, CuInGaSe₂, ZnCuInGaS₂, and ZnCuInGaSe₂.
